(19) United States
(12) Patent Application Publication
(10) Pub. No.: US 2017/0033935 A1
(43) Pub. Date: Feb. 2, 2017

(54) SHORT-TERM SECURITY CERTIFICATES

(71) Applicant: HEWLETT-PACKARD DEVELOPMENT COMPANY, L.P., Houston, TX (US)

(72) Inventors: Robert Graham Clark, Bristol (GB); Timothy John Kelsey, Bristol (GB); Douglas Chivers, Bristol (GB); Stanislaw Izaak Pitucha, Bristol (GB)

(21) Appl. No.: 14/814,786

(22) Filed: Jul. 31, 2015

(51) Int. Cl. H04L 9/32

(52) U.S. Cl. CPC H04L 9/3268

(57) ABSTRACT

Examples disclosed herein relate to security certificate instructions to receive a request for a security certificate, determine whether the request is valid according to at least one authentication rule, and in response to determining that the request is valid, issue the security certificate comprising a short-term lifetime.

### BACKGROUND

Security certificates may be used to authenticate parties to a communication session, such as between a client and a service provider communicating over a network. Such certificates may be issued and signed by a trusted certificate authority that may be queried by each party to validate the other party's certificate. In some situations, a security certificate that has been compromised and should no longer be trusted may be revoked by adding it to a certificate revocation list that may be distributed to the certificate authority.

### BRIEF DESCRIPTION OF THE DRAWINGS

In the accompanying drawings, like numerals refer to like components or blocks. The following detailed description references the drawings, wherein:

FIG. 1 is a block diagram of an example security certificate device;

FIG. 2 is a flowchart of an example of a method for providing security certificates;

FIG. 3 is a block diagram of an example system for providing security certificates using certificate signing requests; and

FIG. 4 is a block diagram of an example system for providing security certificates.

### DETAILED DESCRIPTION

As described above, revocation of an untrusted security certificate supports the use of the public key infrastructure for securing communications. Two methods for revoking certificates are the use of Certificate Revocation Lists (CRL) and the Online Certificate Status Protocol (OCSP). Unfortunately, the widespread distribution of CRLs is often difficult, and OCSP is largely unsupported outside of web browser software. The use of certificates with a short-term lifetime to expiration removes the need for relying on these mechanisms for revoking certificates. Instead, bad certificates simply expire shortly after any potential compromise.

The request, validation and issuing of certificates with short-term lifetimes may be automated. A decision engine may apply semantic and knowledge based tests to each request. Renewal certificates may be denied to untrusted and/or compromised clients rather than revoking old certificates. In this way, the state of all certificates can be guaranteed, the use of all certificates may be tracked, and breaches may be easily detected.

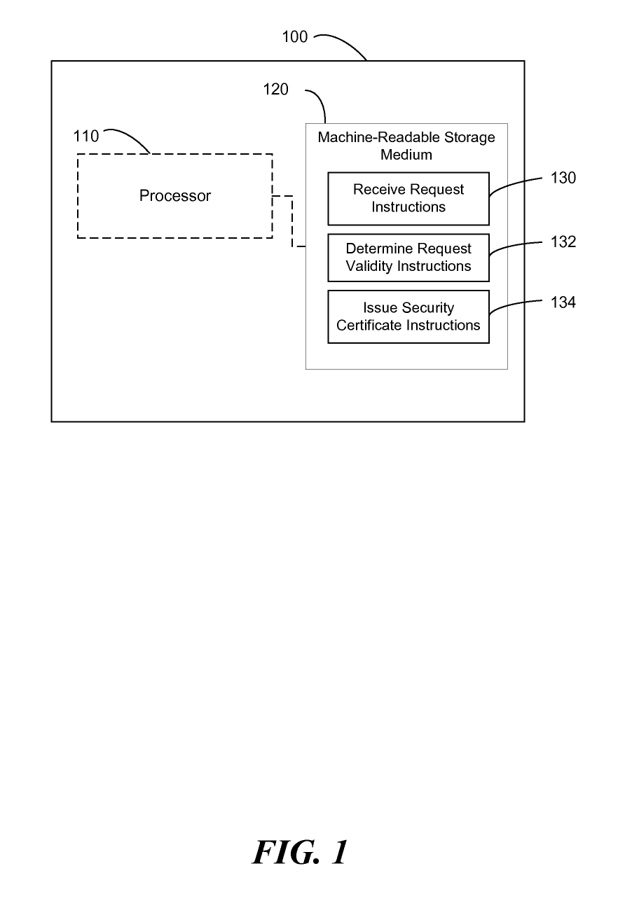

Referring now to the drawings, FIG. 1 is a block diagram of an example security certificate device 100 consistent with disclosed implementations. Security certificate device 100 may comprise a processor 110 and a non-transitory machine-readable storage medium 120. Security certificate device 100 may comprise a computing device such as a server computer, a desktop computer, a laptop computer, a handheld computing device, a smart phone, a tablet computing device, a mobile phone, a network device (e.g., a switch and/or router), or the like.

Processor 110 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 120. In particular, processor 110 may fetch, decode, and execute a plurality of receive request instructions 130, determine request validity instructions 132, and issue security certificate instructions 134 to implement the functionality described in detail below.

Executable instructions may comprise logic stored in any portion and/or component of machine-readable storage medium 120 and executable by processor 110. The machine-readable storage medium 120 may comprise both volatile and/or nonvolatile memory and data storage components. Volatile components are those that do not retain data values upon loss of power. Nonvolatile components are those that retain data upon a loss of power.

The machine-readable storage medium 120 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Receive request instructions 130 may receive a request for a renewable security certificate, such as an X.509 certificate. X.509 is an ITU-T standard for a public key infrastructure (PKI) and Privilege Management Infrastructure (PMI). X.509 specifies, amongst other things, standard formats for public key certificates, certificate revocation lists, attribute certificates, and a certification path validation algorithm. The request may be received, for example, from a client application, such as a web browser, a user, a computer host, a server, and/or a service provider, such as a directory service. The request may be for an initial certificate, such as for a previously unverified public key, and/or for a renewal certificate, for a previously seen and verified public key.

A security certificate may comprise an electronic document used to prove ownership of a public key. The certificate may be signed and verified by a trusted certificate authority. For example, the security certificate may be associated with a public key and a private key. The public key may be distributed to other entities and used to encrypt messages for an owner entity of the security certificate. The owner entity may then decrypt the messages using the private key.

In some implementations, the security certificate may comprise a renewable certificate. Requests for a new certificate and/or for renewal of the renewable certificate may re-use the previous public and private key associated with the certificate for another short-term lifetime when the request is approved.

Determine request validity instructions 132 may determine whether the request is valid according to at least one authentication rule. An authentication rule may comprise a criterion that, if not met by the request, will result in a rejection of the request to issue the certificate.

In some implementations, the criteria of the authentication rule may be directed to field values of a certificate signing request. A certificate signing request (CSR) may comprise a message sent from an applicant to a certificate authority in order to apply for a security certificate. The fields of the CSR may comprise, for example, a domain name, a business name, a department name, a location, and an email address. Evaluation of the domain name, for example, may comprise performing a reverse lookup to ensure that an IP address of the requesting entity matches the domain name of the CSR.

In some implementations, the instructions to determine whether the request is valid may comprise instructions to determine whether the request was received at a correct time. For example, the authentication rule may require that a request for a renewal certificate for a particular entity not be made until an existing certificate is within a threshold amount of time before expiration of its lifetime. If an existing certificate has been issued for a 24-hour lifetime, the rule may require that a renewal request not be made until less than ⅓ of the lifetime, 8 hours, remains before expiration.

In some implementations, the instructions to determine whether the request is valid may comprise instructions to evaluate a source network address associated with the request. For example, requests for certificates may only be honored from a set of IP addresses associated with a particular network subnet and/or from addresses that resolve to a particular domain name. For another example, authentication rules may reference a white list of network adapter MAC addresses.

Once the request is determined to be valid, issue security certificate instructions 134 may issue the security certificate comprising a short-term lifetime. A short-term lifetime may be considered any time significantly shorter than the standard lifetime of one-two years. In some implementations, a short-term lifetime may comprise as little as 48 or 24 hours. The exact lifetime may be configurable and may be different for different requestors. For example, requestors associated with one domain name may receive 24-hour lifetime certificates while requestors associated with another domain name may receive 48-hour lifetime certificates. In some implementations, a requestor may specify a desired certificate's lifetime.

The security certificate may be retrieved from a trusted root certificate authority (CA). The trusted root CA may comprise a trust relationship with the requestor and another entity with whom the requestor wishes to communicate securely, such as a service provider. The trust relationship may be established based on membership or affiliation with the same organization, such as a business' internal CA and/or may rely on commercial CAs with widely distributed certificates that can be easily retrieved and verified such as those included in most web browsers.

Security certificate device 100 may provide the CSR comprising a public key for the requestor to the trusted root CA. The root CA may verify the integrity of the CSR, such as by checking a digital signature and/or a checksum of the CSR, the trusted root CA may sign the security certificate, indicating that the public key has been verified to belong to the requesting owner of the security certificate. The signed certificate may then be provided to the requestor.

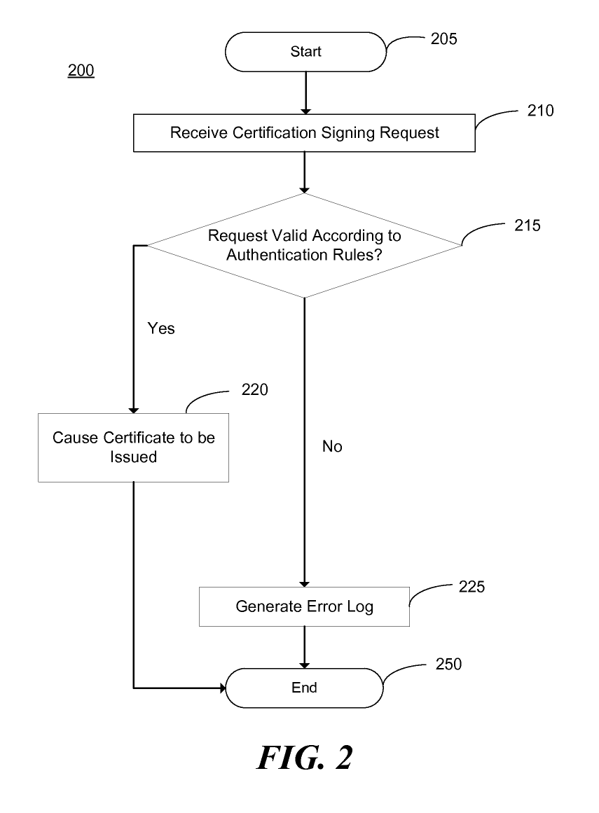

FIG. 2 is a flowchart of a method 200 for security certificate consistent with disclosed implementations. Although execution of method 200 is described below with reference to the components of security certificate device 100, other suitable components for execution of method 200 may be used.

Method 200 may begin in stage 205 and proceed to stage 210 where device 100 may receive a certificate signing request from a requestor. For example, receive request instructions 130 may receive a request for a security certificate, such as an X.509 certificate. The request may be received, for example, from a client application, such as a web browser, a user, a computer host, a server, and/or a service provider, such as a directory service. The request may be for an initial certificate, such as for a previously unverified public key, and/or for a renewal certificate, for a previously seen and verified public key.

Method 200 may then advance to stage 215 where device 100 may determine according to a plurality of authentication rules, whether the certificate signing request is valid. For example, determine request validity instructions 132 may determine whether the request is valid according to at least one authentication rule. An authentication rule may comprise a criterion that, if not met by the request, will result in a rejection of the request to issue the certificate. For example, an authentication rule may determine whether the requestor is on a black list of clients and/or service providers who are not permitted to receive and/or renew security certificates.

In some implementations, the criteria of the authentication rule may be directed to field values of a certificate signing request (CSR) and determining whether the CSR is malformed. The CSR may comprise a message sent from an applicant to a certificate authority in order to apply for a security certificate. The fields of the CSR may comprise, for example, a domain name, a business name, a department name, a location, and an email address. Evaluation of the domain name, for example, may comprise performing a reverse lookup to ensure that an IP address of the requesting entity matches the domain name of the CSR.

In some implementations, the instructions to determine whether the request is valid may comprise instructions to determine whether the request was received at a correct time. For example, the authentication rule may require that a request for a renewal certificate for a particular entity not be made until an existing certificate is within a threshold amount of time before expiration of its lifetime. If an existing certificate has been issued for a 24-hour lifetime, the rule may require that a renewal request not be made until less than ⅓ of the lifetime, 8 hours, remains before expiration.

In some implementations, the instructions to determine whether the request is valid may comprise instructions to evaluate a source network address associated with the request. For example, requests for certificates may only be honored from a set of IP addresses associated with a particular network subnet and/or from addresses that resolve to a particular domain name. For another example, authentication rules may reference a white list of network adapter MAC addresses.

If the request is determined to be valid at stage 215, method 200 may advance to stage 220 where device 100 may causing a security certificate comprising a short-term lifetime to be issued to the requestor. For example, issue security certificate instructions 134 may issue the security certificate comprising a short-term lifetime. A short-term lifetime may be considered any time significantly shorter than the standard lifetime of one-two years. In some implementations, a short-term lifetime may comprise as little as 48 or 24 hours. The exact lifetime may be configurable and may be different for different requestors. For example, requestors associated with one domain name may receive 24-hour lifetime certificates while requestors associated with another domain name may receive 48-hour lifetime certificates. In some implementations, a requestor may specify a desired certificate's lifetime.

The security certificate may be retrieved from a trusted root certificate authority (CA). Security certificate device 100 may provide the CSR comprising a public key for the requestor to the trusted root CA. The root CA may verify the integrity of the CSR, such as by checking a digital signature and/or a checksum of the CSR, the trusted root CA may sign the security certificate, indicating that the public key has been verified to belong to the requesting owner of the security certificate. The signed certificate may then be provided to the requestor.

If the request is determined not to be valid at stage 215, method 200 may advance to stage 225 where device 100 may generate an error log message associated with the requestor. The error log may comprise details about the requestor, such as an IP address, hostname, user who submitted the request, a reason for rejecting the request, such as which authentication rule was not satisfied, a time, and/or a date. In some implementations, a bad request and/or a series of bad requests may result in the requestor being blacklisted from receiving security certificates.

Method 200 may then end at stage 250.

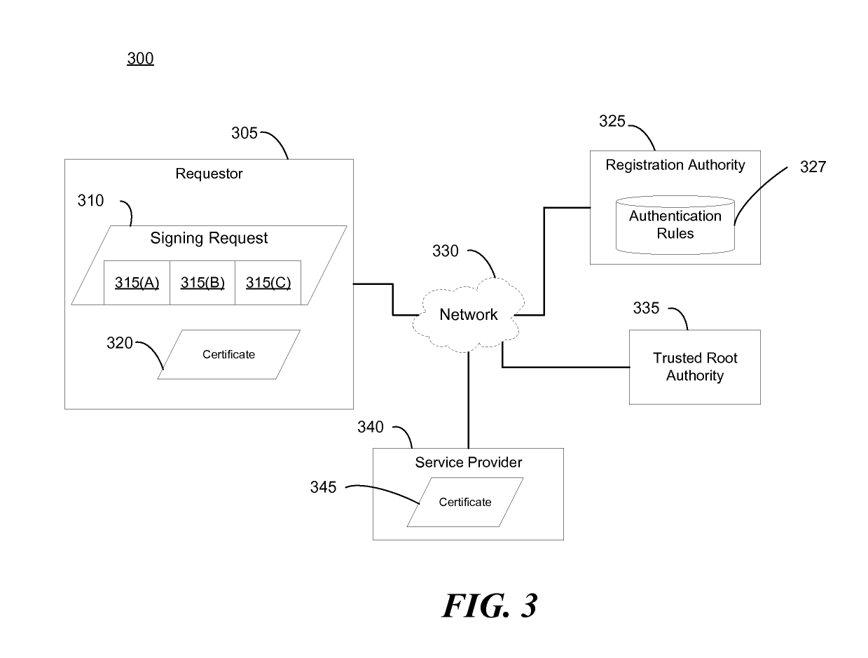

FIG. 3 is a block diagram of an example system 300 for providing security certificates using certificate signing requests (CSRs). System 300 may comprise a requestor 305, such as a client host and/or application comprising a security certificate 320. System 300 may further comprise a registration authority 325 comprising a plurality of authentication rules 327. Requestor 305 may provide a certificate signing request 310 comprising a plurality of fields 315(A)-(C) to registration authority 325 via a network 330. Network 330 may comprise a private network, such a business' internal local area network (LAN), a cellular data network, a public network such as the Internet, etc.

Registration authority may validate the CSR according to authorization rules 327 and, if the request is valid, may relay the request to a trusted root certification authority (CA) 335. In some implementations, registration authority 325 and trusted root CA 335 may comprise the same entity. Trusted root CA 335 may sign certificate 320 for requestor 305. Requestor 305 may then use certificate 320 to authenticate with a service provider 340 and may validate the identity of service provider 340 using a service provider security certificate 345. Service provider security certificate 345 may also be signed by trusted root CA 335 and may be renewed based on requests from service provider 340 to registration authority 325.

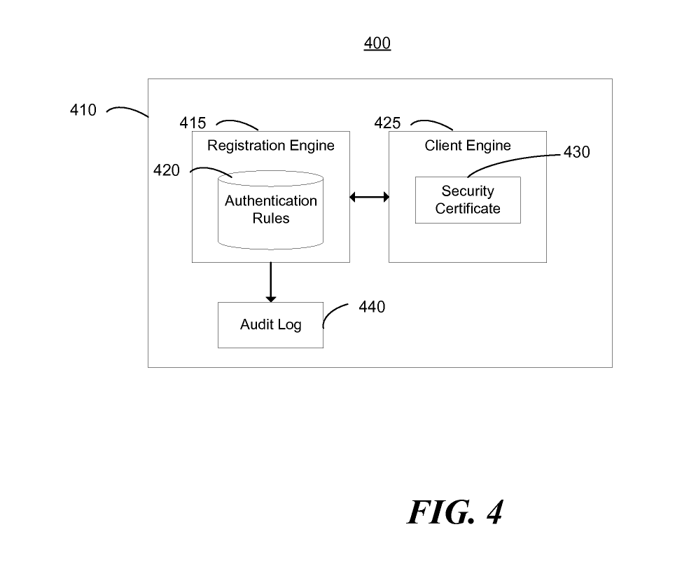

FIG. 4 is a block diagram of an example system 400 for providing security certificates comprising a computing device 410. Computing device 410 may comprise, for example, a general and/or special purpose computer, server, mainframe, desktop, laptop, tablet, smart phone, game console, and/or any other system capable of providing computing capability consistent with providing the implementations described herein. Computing device 410 may comprise any combination of hardware and programming to implement the functionalities of the respective components. In examples described herein, such combinations of hardware and programming may be implemented in a number of different ways. For example, programming may comprise processor executable instructions stored on a non-transitory machine-readable storage medium and the hardware for the engines may include a processing resource to execute those instructions.

Device 410 may comprise a client engine 425 to determine whether a security certificate 430 comprising an X.509 certificate associated with the client engine is within a threshold time of an expiration time. In response to determining that the security certificate is nearing the expiration time, client engine 425 may request a renewal of the security certificate from a registration engine 415. The request may comprise a certificate signing request (CSR) 310 comprising a plurality of fields 315(A)-(C). The registration engine 415 may comprise a trust relationship with the client engine 425. The threshold time may be configurable and may be defined in absolute (e.g., 4 hours) and/or relative (e.g., ⅓ of the certificate's total lifetime) values.

Device 410 may comprise a registration engine 415 to evaluate the request for the replacement certificate according to a plurality of authentication rules 420, wherein a first authentication rule evaluates a data value of at least one of the plurality of fields 315(A)-(C) associated with the certificate signing request 310. Registration engine 415 may cause the renewal of the security certificate to be issued, wherein the renewed security certificate comprises a short-term lifetime.

Registration engine 415 may execute receive request instructions 130 to receive a request for a security certificate. The request may be received, for example, from a client application, such as a web browser, a user, a computer host, a server, and/or a service provider, such as a directory service. The request may be for an initial certificate, such as for a previously unverified public key, and/or for a renewal certificate, for a previously seen and verified public key.

Registration engine 415 may determine, according to a plurality of authentication rules, whether the certificate signing request is valid. For example, determine request validity instructions 132 may determine whether the request is valid according to at least one authentication rule. An authentication rule may comprise a criterion that, if not met by the request, will result in a rejection of the request to issue the certificate. For example, an authentication rule may determine whether the requestor is on a black list of clients and/or service providers who are not permitted to receive and/or renew security certificates.

In some implementations, the criteria of the authentication rule may be directed to field values of a certificate signing request (CSR) and determining whether the CSR is malformed. The CSR may comprise a message sent from an applicant to a certificate authority in order to apply for a security certificate. The fields of the CSR may comprise, for example, a domain name, a business name, a department name, a location, and an email address. Evaluation of the domain name, for example, may comprise performing a reverse lookup to ensure that an IP address of the requesting entity matches the domain name of the CSR.

In some implementations, the instructions to determine whether the request is valid may comprise instructions to determine whether the request was received at a correct time. For example, the authentication rule may require that a request for a renewal certificate for a particular entity not be made until an existing certificate is within a threshold amount of time before expiration of its lifetime. If an existing certificate has been issued for a 24-hour lifetime, the rule may require that a renewal request not be made until less than ⅓ of the lifetime, 8 hours, remains before expiration.

In some implementations, the instructions to determine whether the request is valid may comprise instructions to evaluate a source network address associated with the request. For example, requests for certificates may only be honored from a set of IP addresses associated with a particular network subnet and/or from addresses that resolve to a particular domain name. For another example, authentication rules may reference a white list of network adapter MAC addresses.

Registration engine 415 may use issue security certificate instructions 134 to issue the security certificate comprising a short-term lifetime. A short-term lifetime may be considered any time significantly shorter than the standard lifetime of one-two years. In some implementations, a short-term lifetime may comprise as little as 48 or 24 hours. The exact lifetime may be configurable and may be different for different requestors. For example, requestors associated with one domain name may receive 24-hour lifetime certificates while requestors associated with another domain name may receive 48-hour lifetime certificates. In some implementations, a requestor may specify a desired certificate's lifetime.

The security certificate may be retrieved from a trusted root certificate authority (CA). The trusted root CA may comprise a trust relationship with the requestor and another entity with whom the requestor wishes to communicate securely, such as a service provider. The trust relationship may be established based on membership or affiliation with the same organization, such as a business' internal CA and/or may rely on commercial CAs with widely distributed certificates that can be easily retrieved and verified such as those included in most web browsers.

Registration engine 415 may provide the CSR comprising a public key for the requestor (e.g., client engine 425) to the trusted root CA. The root CA may verify the integrity of the CSR, such as by checking a digital signature and/or a checksum of the CSR, the trusted root CA may sign the security certificate, indicating that the public key has been verified to belong to the requesting owner of the security certificate. The signed certificate may then be provided to the requestor.

Registration engine 415 may create an audit log 440 associated with issuing the renewal of the security certificate whether the authentication rules 420 authorize the renewal or not. For example, a successful renewal may simply result in a log entry that client engine 425 received a renewal for security certificate 430 at the date/time the renewal was issued. An unsuccessful renewal may generate an error log. The error log may comprise details about the requestor, such as an IP address, hostname, user who submitted the request, a reason for rejecting the request, such as which authentication rule was not satisfied, a time, and/or a date. In some implementations, a bad request and/or a series of bad requests may result in the requestor being blacklisted from receiving security certificates.

The disclosed examples may include systems, devices, computer-readable storage media, and methods for security certificate. For purposes of explanation, certain examples are described with reference to the components illustrated in the Figures. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

We claim:

1. A non-transitory machine-readable storage medium comprising instructions for logic to:
receive a request for a renewable security certificate;
determine whether the request is valid according to at least one authentication rule; and
in response to determining that the request is valid, issue the renewable security certificate comprising a short-term lifetime.

2. The non-transitory machine-readable medium of claim 1, wherein the renewable certificate is associated with a pre-defined renewal window.

3. The non-transitory machine-readable medium of claim 1, wherein the instructions to determine whether the request is valid comprise instructions to evaluate a plurality of field values of the request.

4. The non-transitory machine-readable medium of claim 3, wherein the plurality of field values are associated with a certificate signing request.

5. The non-transitory machine-readable medium of claim 1, wherein the instructions to determine whether the request is valid comprise instructions to determine whether the request was received at a correct time.

6. The non-transitory machine-readable medium of claim 1, wherein the instructions to determine whether the request is valid comprise instructions to evaluate a source network address associated with the request.

7. The non-transitory machine-readable medium of claim 1, wherein the instructions to issue the security certificate comprise instructions to retrieve a signed certificate from a trusted root certificate authority.

8. A computer-implemented method, comprising:
receiving a certificate signing request from a requestor;
determining, according to a plurality of authentication rules, whether the certificate signing request is valid;
in response to determining that the certificate signing request is valid, causing a renewable security certificate comprising a short-term lifetime to be issued to the requestor; and
in response to determining that the certificate signing request is not valid, generating an error log message associated with the requestor.

9. The computer-implemented method of claim 8, wherein determining whether the certificate signing request is valid comprises determining whether the requestor is associated with a black list of requestors.

10. The computer-implemented method of claim 8, wherein determining whether the certificate signing request is valid comprises determining whether the certificate signing request is malformed.

11. The computer-implemented method of claim 8, wherein determining whether the certificate signing request is valid comprises determining whether the requestor is associated with an authorized network address.

12. The computer-implemented method of claim 8, wherein causing the renewable security certificate to be issued to the requestor comprises requesting a trusted root authority to sign the security certificate for the requestor.

13. The computer-implemented method of claim 10, wherein the trusted root authority comprises a trust relationship with the requestor and at least one service provider accessed by the requestor.

14. A system, comprising:
a client engine to:
determine whether a security certificate associated with the client engine is within a threshold time of an expiration time, and
in response to determining that the security certificate is nearing the expiration time:
request a renewal of the security certificate from a registration engine, wherein the request comprises a certificate signing request comprising a plurality of fields and wherein the certificate authority engine comprises a trust relationship with the client engine; and
the registration engine to:
evaluate the request for the renewal of the security certificate according to a plurality of authentication rules, wherein a first authentication rule evaluates a data value of at least one of the plurality of fields associated with the certificate signing request,
cause the renewal of the security certificate to be issued, wherein the renewed security certificate comprises a short-term lifetime, and
create an audit log associated with issuing the renewal of the security certificate.

15. The system of claim 14, wherein a second authentication rule evaluates the request for the renewal of the security certificate according to whether the client engine is associated with an authorized network address.
